(19) United States
(12) Patent Application Publication
(10) Pub. No.: US 2016/0208842 A1
(43) Pub. Date: Jul. 21, 2016

(54) SCREW

(71) Applicant: TENG-HUNG LIN, Kaohsiung Hsien (TW)

(72) Inventor: TENG-HUNG LIN, Kaohsiung Hsien (TW)

(21) Appl. No.: 14/599,558

(22) Filed: Jan. 19, 2015

(51) Int. Cl. F16B 25/00

(52) U.S. Cl. CPC F16B 25/0057

(57) ABSTRACT

A screw comprises: a screw head; a first screw rod extending from the screw head; and a second screw rod extending from a lower end of the first screw rod; a third thread and a fourth screw alternatively circles around the second screw rod; an angle between an upper surface of the third thread and an adjacent lateral surface of the fourth thread being larger than 90 degrees; and an angle between an upper surface of the fourth thread and a lateral surface of the third thread being larger than 90 degrees. Or only one thread circles around the second screw rod; an angle between an upper surface of the thread and an adjacent lateral surface of the second screw rod being larger than 90 degrees. There may be only one thread circling on the first screw rod, or two threads alternatively circling around the first screw rod.

### FIELD OF THE INVENTION

The present invention relates to screws, and in particular to a two stage screw, in that an angle between an upper surface of a thread on a lower stage and an adjacent lateral surface being larger than 90 degrees;

### BACKGROUND OF THE INVENTION

Generally, screws are used in many different fields, however, designs of screws considers the factors, such as drilling speed, drag removing, and final retaining effect. To achieve above objects, various screws are developed, such as single stage screws, two stage screws, or same guiding angles, and different guiding angles, etc.

Similarly, threads of screws also considers properties of the combining materials, for example, using to combining with plaster plates or thin iron plates, etc. Screws are driven into the plates by a driving gun in one side, while it is possible that the plates explode in another side so that the gaps between plates are larges and thus the combining force is weak.

### SUMMARY OF THE INVENTION

Accordingly, the object of the present invention is to improve the above mentioned prior arts, the present invention provides a screw, wherein when the screws of the present invention are drilled into to a thin plate, such as a plaster plate or a thin iron plate (these are not used to confine the scope of the present invention) by using an air driver, another side of the plate does not explode by the impact force of the screw.

To achieve above object, the present invention provides a screw, comprising: a screw head; a first screw rod extending from a lower side of the screw head; and a second screw rod extending from a lower end of the first screw rod; a third thread and a fourth screw alternatively circles around the second screw rod; an angle between an upper surface of the third thread and an adjacent lateral surface of the fourth thread being larger than 90 degrees; and an angle between an upper surface of the fourth thread and a lateral surface of the third thread being larger than 90 degrees. There may be one thread circling on the first screw rod, or a first thread and a second thread alternatively circling around the first screw rod. The third thread and the fourth thread extend to a tip end of the second screw rod.

Or the present invention provides a screw comprising: a screw head; a first screw head extending from a lower side of the screw rod; and a second screw rod extending from a lower end of the first screw rod; a thread circles around the second screw rod; an angle between an upper surface of the thread and an adjacent lateral surface of the second screw rod being larger than 90 degrees. There may be one thread circling on the first screw rod, or a first thread and a second thread alternatively circling around the first screw rod.

### BRIEF DESCRIPTION OF THE DRAWINGS

FIG. 1 shows the embodiment of the present invention.

FIG. 2 is a partial cross sectional view of the present invention.

### DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

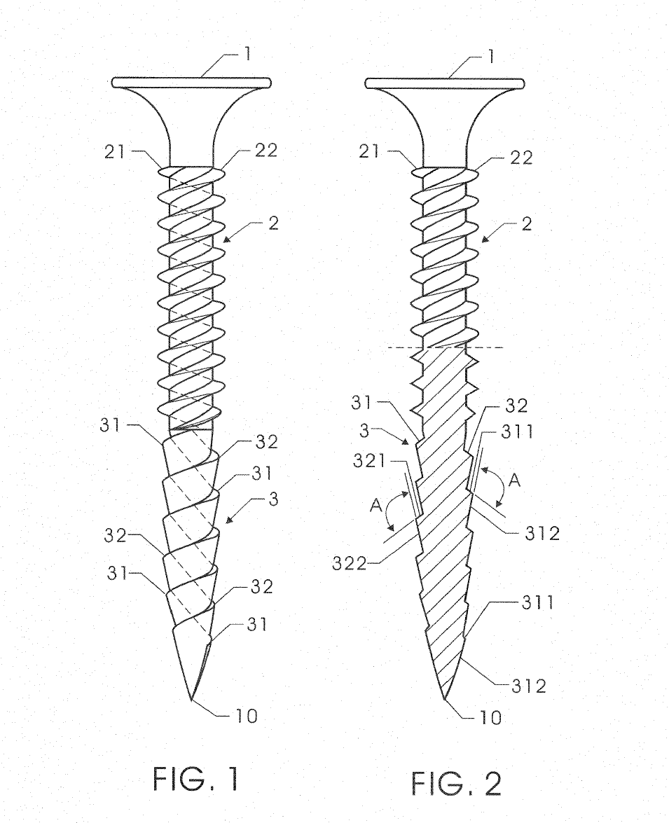

With reference to FIGS. 1 and 2, the screw of the present invention serves to drill the materials, such as plaster plates, or thin iron plates, and others. The screw of the present invention includes the following elements.

A screw head 1 is included.

A first screw rod 2 extends from a lower side of the screw head 1; and a first thread 21 and a second thread 22 alternatively circle around the first screw rod 1. However, in the present invention, it is also permissible that there is only one thread on the first screw rod 2.

A second screw rod 3 extends from a lower end of the first screw rod 2;

and a third thread 31 and a fourth screw 32 alternatively circles around the second screw rod 2. An angle between an upper surface 311 of the third thread 31 and an adjacent lateral surface 322 of the fourth thread 32 are larger than 90 degrees; and an angle between an upper surface 321 of the fourth thread 32 and a lateral surface 312 of the third thread 3 is larger than 90 degrees. The third thread 31 and the fourth thread 32 extend to a tip end of the second screw rod 2.

It is also permissible that there are only one thread on the second screw rod 3. At this embodiment, the angle between an upper surface 311 of the third thread 31 and an adjacent surface of the second screw rod is larger than 90 degrees; and the thread extends to a tip end of the second screw rod.

However, above embodiment is based on the drawings of the present invention, while other combinations of threads in the first and second screw rods are permissible, it is only needed that the first screw rod 2 has only one screw or the second screw rod 3 has only one thread. It is only needed that an angle between an upper surface of the thread on the second screw rod and a lateral surface adjacent to the upper surface of the thread on the second screw rod is larger than 90 degrees.

By above mentioned structure, when the screws of the present invention are drilled into to a thin plate, such as a plaster plate or a thin iron plate (these are not used to confine the scope of the present invention) by using an air driver, another side of the plate does not explode by the impact force of the screw.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A screw, comprising:
a screw head;
a first screw rod extending from a lower side of the screw head; and
a second screw rod extending from a lower end of the first screw rod; a third thread and a fourth screw alternatively circling around the second screw rod; an angle between an upper surface of the third thread and an adjacent lateral surface of the fourth thread being larger than 90 degrees; and an angle between an upper surface of the fourth thread and a lateral surface of the third thread being larger than 90 degrees; and the third thread and the fourth thread extending to a tip end of the second screw rod.

2. The screw as claimed in claim 1, wherein another thread is formed on the first screw rod.

3. The screw as claimed in claim 1, wherein a first thread and a second thread are alternatively circle around the first screw rod.

4. A screw, comprising:
a screw head;
a first screw rod extending from a lower side of the screw head; and
a second screw rod extending from a lower end of the first screw rod; a thread circling around the second screw rod; an angle between an upper surface of the thread and an adjacent lateral surface of the second screw rod being larger than 90 degrees; and the thread extends to a tip end of the second screw rod.

5. The screw as claimed in claim 1, wherein another thread is formed on the first screw rod.

6. The screw as claimed in claim 1, wherein a first thread and a second thread are alternatively circle around the first screw rod.
